(19) United States
(12) Patent Application Publication
(10) Pub. No.: US 2025/0348032 A1
(43) Pub. Date: Nov. 13, 2025

(54) IMAGE FORMING APPARATUS, CONTROL METHOD, AND STORAGE MEDIUM

(71) Applicant: Konica Minolta, Inc., Tokyo (JP)

(72) Inventors: Masahiro ONODERA, Tokyo (JP); Yu MUKOBAYASHI, Tokyo (JP); Kuniaki KASHIWAKURA, Toyohashi-shi (JP); Hiroyuki SAITO, Tokyo (JP)

(21) Appl. No.: 19/200,923

(22) Filed: May 7, 2025

(30) Foreign Application Priority Data
May 9, 2024 (JP) 2024-076468

(51) Int. Cl. G03G 15/00; G03G 21/00

(52) U.S. Cl. CPC G03G 15/5008; G03G 21/007

(57) ABSTRACT

Provided is an image forming apparatus including a hardware processor and an image forming section including an image bearing member and a lubricant application unit. The lubricant application unit includes a solidified lubricant stick, a lubricant brush, and a lubricant pressing part. The hardware processor controls the image bearing member and the lubricant brush according to a linear velocity ratio, a ratio of a surface velocity of the lubricant brush with respect to a surface velocity of the image bearing member in an initial stage of endurance. The linear velocity ratio is calculated based on an initial rubbing force and an ease of scraping of the lubricant. The hardware processor corrects the linear velocity ratio by a correction value of the linear velocity ratio calculated based on an endurance correction coefficient, the initial rubbing force, a terminal rubbing force, and the number of printed sheets by the image forming section.

### CROSS-REFERENCE TO RELATED APPLICATIONS

The entire disclosure of Japanese Patent Application No. 2024-076468 filed on May 9, 2024, is incorporated herein by reference in its entirety.

### BACKGROUND OF THE INVENTION

### Technical Field

The present invention relates to an image forming apparatus, a control method, and a storage medium.

### Description of Related Art

Generally, in an image forming apparatus using an electrophotographic process, when a toner image on a photoreceptor (image bearing member) is transferred to an intermediate transfer belt, some toner particles are not transferred and remain on the photoreceptor. Therefore, the image forming apparatus includes a cleaning device that removes residues such as residual toner on the photoreceptor. However, when the adhesion force between the toner particles and the photoreceptor is large, the cleaning device cannot sufficiently remove the residues on the photoreceptor. This causes a cleaning failure.

In order to solve the above-described problem, a technique is known in which a lubricant is applied onto the photoreceptor to reduce the adhesion force between the toner particles and the photoreceptor, thereby suppressing cleaning failures. However, residues on the photoreceptor cannot be sufficiently cleaned at a place where the application amount of the lubricant is small. As a result, the toner particles slip through the cleaning blade, causing a vertical streak-like image defect (vertical streak) on the formed image. Therefore, the lubricant is required to be uniformly applied in an appropriate amount onto the photoreceptor. That is, during the operation of the image forming apparatus, the amount of the lubricant consumed with respect to the number of printed sheets (=amount of change in weight of lubricant/sliding distance of lubricant) is required to be constant. The sliding distance of the lubricant corresponds to the number of printed sheets in the image forming apparatus.

A specific example of a lubricant application mechanism for applying a lubricant onto a photoreceptor will be described. The lubricant application mechanism presses a lubricant stick containing a solidified lubricant against a lubricant brush, and rotates the lubricant brush to scrape off the lubricant from the lubricant stick and supply the lubricant to the photoreceptor.

The image forming apparatus controls a linear velocity ratio, which is a surface velocity ratio of the photoreceptor to a surface velocity of the lubricant brush, so as to keep a lubricant consumption amount constant with respect to the number of printed sheets. Specifically, the image forming apparatus corrects the linear velocity ratio in accordance with an endurance change in the pressing force between the lubricant brush and the lubricant stick during endurance.

Regarding correction during endurance in an image forming apparatus, Japanese Unexamined Patent Publication No. 2019-128588 describes an image forming apparatus that corrects process conditions on the basis of first correction information on a photoreceptor and second correction information on a developing unit.

However, since the rubbing force of the lubricant brush against the lubricant during endurance varies depending on how easily the lubricant can be scraped, appropriate correction may not be performed at the linear velocity ratio. Thus, the amount of the lubricant consumed relative to the number of printed sheets cannot be kept constant, which may cause vertical streaks.

An object of the present invention is to provide an image forming apparatus, a control method, and a storage medium capable of suppressing an image defect caused by the amount of a lubricant on an image bearing member.

### SUMMARY OF THE INVENTION

To achieve at least one of the abovementioned objects, according to an aspect of the present invention, an image forming apparatus reflecting one aspect of the present invention includes:
an image forming section including an image bearing member that bears a toner image and a lubricant application unit that applies lubricant to the image bearing member; and
a hardware processor that controls the image forming section,
wherein the lubricant application unit includes: a solidified lubricant stick; a lubricant brush that scrapes off the lubricant from the lubricant stick and supplies the lubricant to the image bearing member; and a lubricant pressing part that presses the lubricant stick against the lubricant brush,
wherein the hardware processor:
   controls the image bearing member and the lubricant brush according to a linear velocity ratio which is a ratio of a surface velocity of the lubricant brush with respect to a surface velocity of the image bearing member in an initial stage of endurance, the linear velocity ratio being calculated based on an initial rubbing force and an ease of scraping of the lubricant, the initial rubbing force being a rubbing force of the lubricant brush in a state where the lubricant stick is pressed against the lubricant brush with an initial pressing force in the initial stage of the endurance; and corrects the linear velocity ratio by a correction value of the linear velocity ratio calculated based on an endurance correction coefficient according to an endurance change of the lubricant brush determined by the ease of scraping of the lubricant, the initial rubbing force, a terminal rubbing force which is a rubbing force of the lubricant brush in a state where the lubricant stick is pressed to the lubricant brush by a pressing force weaker than the initial pressing force in a terminal stage of the endurance, and the number of printed sheets by the image forming section,
wherein the pressing force between the lubricant brush and the lubricant stick in the terminal stage of the endurance is in a proportional relationship with the terminal rubbing force.

According to another aspect of the present invention, provided is a control method executed by an image forming apparatus, the image forming apparatus comprising:
an image forming section including an image bearing member that bears a toner image and a lubricant application unit that applies a lubricant to the image bearing member,
wherein the lubricant application unit includes: a solidified lubricant stick; a lubricant brush that scrapes off lubricant from the lubricant stick and supplies the lubricant to the image bearing member; and a lubricant pressing portion that presses the lubricant stick against the lubricant brush,
wherein the control method comprises controlling the image forming section,
wherein in the controlling,
   the image bearing member and the lubricant brush are controlled according to a linear velocity ratio which is a ratio of a surface velocity of the lubricant brush with respect to a surface velocity of the image bearing member in an initial stage of endurance, the linear velocity ratio being calculated based on an initial rubbing force and an ease of scraping of the lubricant, the initial rubbing force being a rubbing force of the lubricant brush in a state where the lubricant stick is pressed against the lubricant brush with an initial pressing force in the initial stage of the endurance; and
   the linear velocity ratio is corrected by a correction value of the linear velocity ratio calculated based on an endurance correction coefficient according to an endurance change of the lubricant brush determined by the ease of scraping of the lubricant, the initial rubbing force, a terminal rubbing force which is a rubbing force of the lubricant brush in a state where the lubricant stick is pressed to the lubricant brush by a pressing force weaker than the initial pressing force in a terminal stage of the endurance, and the number of printed sheets by the image forming section,
wherein the pressing force between the lubricant brush and the lubricant stick in the terminal stage of the endurance is in a proportional relationship with the terminal rubbing force.

According to another aspect of the present invention, a non-transitory computer-readable storage medium stores a program that causes a computer of an image forming apparatus to function as a controller,
wherein the image forming apparatus comprises an image forming section including an image bearing member that bears a toner image and a lubricant application unit that applies a lubricant on the image bearing member,
wherein the lubricant application unit includes: a solidified lubricant stick; a lubricant brush that scrapes off lubricant from the lubricant stick and supplies the lubricant to the image bearing member; and a lubricant pressing portion that presses the lubricant stick against the lubricant brush,
wherein the controller:
   controls the image bearing member and the lubricant brush according to a linear velocity ratio which is a ratio of a surface velocity of the lubricant brush with respect to a surface velocity of the image bearing member in an initial stage of endurance, the linear velocity ratio being calculated based on an initial rubbing force and an ease of scraping of the lubricant, the initial rubbing force being a rubbing force of the lubricant brush in a state where the lubricant stick is pressed against the lubricant brush with an initial pressing force in the initial stage of the endurance; and
   corrects the linear velocity ratio by a correction value of the linear velocity ratio calculated based on an endurance correction coefficient according to an endurance change of the lubricant brush determined by the ease of scraping of the lubricant, the initial rubbing force, a terminal rubbing force which is a rubbing force of the lubricant brush in a state where the lubricant stick is pressed to the lubricant brush by a pressing force weaker than the initial pressing force in a terminal stage of the endurance, and the number of printed sheets by the image forming section,
wherein the pressing force between the lubricant brush and the lubricant stick in the terminal stage of the endurance is in a proportional relationship with the terminal rubbing force.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 shows a schematic configuration of an image forming apparatus;

FIG. 2 is a block diagram showing a main functional configuration of the image forming apparatus;

FIG. 3 shows a schematic configuration of a cleaning unit and a lubricant application unit;

FIG. 4 shows a relationship between a pressing force to a lubricant brush and a rubbing force of the lubricant brush;

FIG. 5 is a flowchart showing a flow of a linear velocity ratio control processing;

FIG. 6A is a diagram showing an example of the rubbing force of the lubricant brush, the ease of scraping of the lubricant, and the linear velocity ratio in comparative examples;

FIG. 6B shows an example of a lubricant consumption amount in comparative examples;

FIG. 7A is a diagram showing an example of the rubbing force of the lubricant brush, the ease of scraping of the lubricant, the endurance correction coefficient, and the linear velocity ratio according to the present embodiment; and

FIG. 7B is a diagram showing an example of the lubricant consumption amount in the present embodiment.

### DETAILED DESCRIPTION

Hereinafter, one or more embodiments of the present invention will be described with reference to the drawings. However, the scope of the invention is not limited to the disclosed embodiments.

An embodiment of the present invention will be described below with reference to the drawings. The following description is an embodiment of the present invention and does not limit the present disclosure.

### <Configuration of Image Forming Apparatus >

The configuration of the image forming apparatus 1 according to the present embodiment will be described.

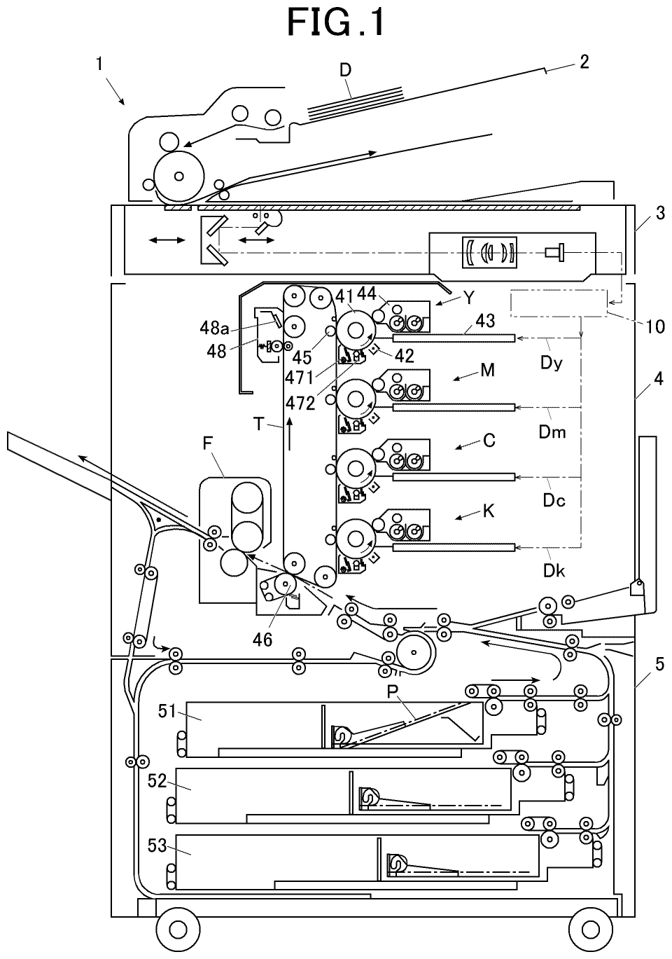

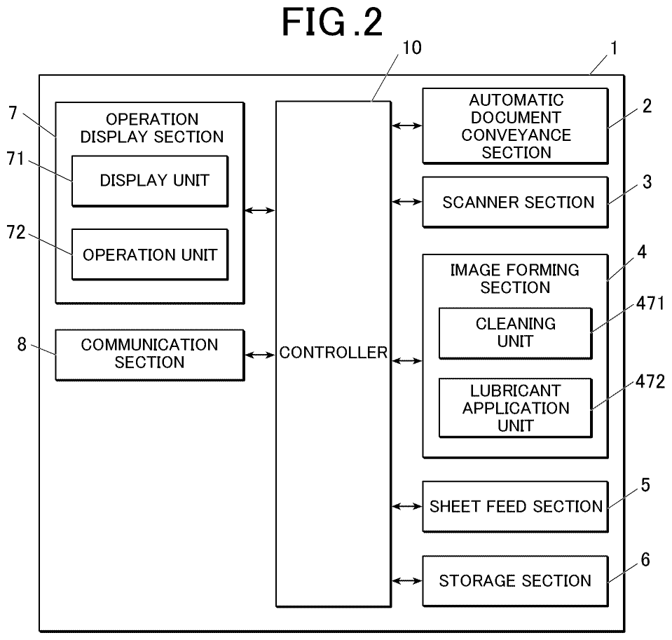

The image forming apparatus 1 is a color image forming apparatus of an intermediate transfer method utilizing an electrophotographic process technology. As shown in FIGS. 1 and 2, the image forming apparatus 1 includes an automatic document conveyance section 2, a scanner section 3, an image forming section 4, a sheet feed section 5, a storage section 6, an operation display section 7, a communication section 8, and a controller 10 (hardware processor).

The automatic document conveyance section 2 includes a placement tray on which a document D is placed, a mechanism for conveying the document D, a conveyance roller, and the like, and conveys the document D to a predetermined conveyance path.

The scanner section 3 includes an optical system such as a light source and a reflector, irradiates the document D conveyed through the predetermined conveyance path or the document D placed on a platen glass with the light source, and receives reflected light. Next, the scanner section 3 converts the received reflected light into electrical signals and outputs the electrical signals as image data to the controller 10.

The image forming section 4 includes a yellow image forming unit Y, a magenta image forming unit M, a cyan image forming unit C, a black image forming unit K, an intermediate transfer belt T, a secondary transfer roller 46, a fixing unit F, and a cleaning unit 48.

The image forming units YMCK form toner images of yellow, magenta, cyan, and black on the photoreceptors 41, respectively, and primarily transfer the toner images of YMCK colors formed on the photoreceptors 41 to the intermediate transfer belt T.

Each of the image forming units YMCK includes a photoreceptor 41, a charging device 42, an exposure device 43, a developing device 44, a primary transfer roller 45, a cleaning unit 471, and a lubricant application unit 472. The photoreceptor 41 is an image bearing member that carries a toner image thereon.

The photoreceptor 41 is in the form of a drum and is rotationally driven in a direction of an arrow shown in FIG. 1. The charging device 42 uniformly charges the surface of the photoreceptor 41.

The exposure device 43 exposes the surface of the photoreceptor 41 charged by the charging device 42 to form an electrostatic latent image. Specifically, the exposure device 43 exposes the non-image region of the photoreceptor 41 based on the image data Dy, Dm, Dc, and Dk from the controller 10, removes the charge of the exposed portion, and forms an electrostatic latent image in the image region of the photoreceptor 41.

The developing device 44 visualizes the electrostatic latent image formed by the exposure device 43 with a developer including a toner. The primary transfer roller 45 primarily transfers the toner image formed on the photoreceptor 41 onto the intermediate transfer belt T moving in a direction of an arrow shown in FIG. 1.

The cleaning unit 471 removes toner on the photoreceptor 41 that has passed through the transfer region. The photoreceptor 41 from which the toner on the surface has been collected by the cleaning unit 471 is charged again by the charging device 42, and the next electrostatic latent image is formed, the formation of a toner image is thereby repeated.

The lubricant application unit 472 supplies the lubricant to the photoreceptor 41.

The secondary transfer roller 46 secondarily transfers the toner images transferred onto the intermediate transfer belt T onto a sheet P conveyed from one of the sheet feed trays 51 to 53 of the sheet feed section 5. Thereafter, the fixing unit F fixes the toner image onto the sheet P. The above-described constituent elements of each of the image forming units YMCK are elongated in the axis direction of the photoreceptors 41.

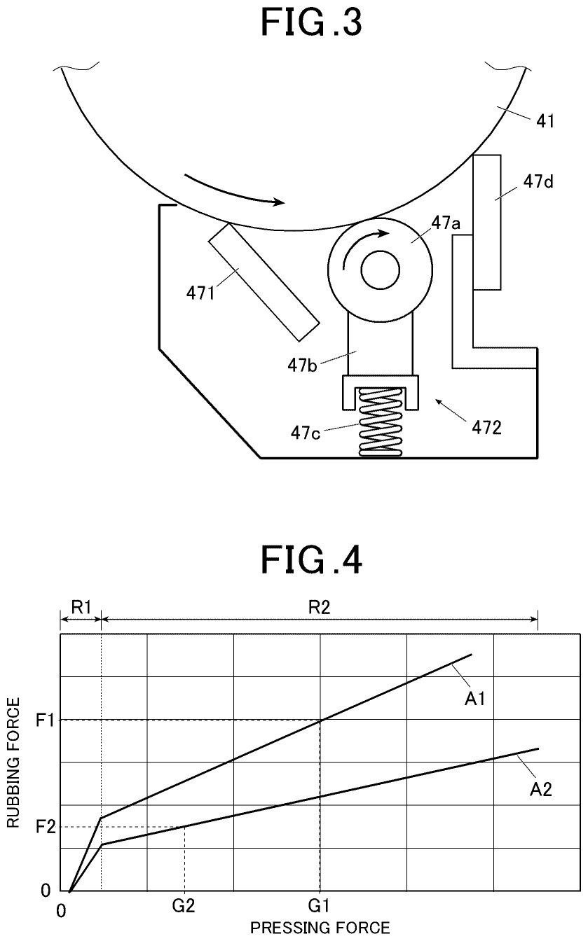

FIG. 3 shows a schematic configuration of the cleaning unit 471 and the lubricant application unit 472.

As shown in FIG. 3, the lubricant application unit 472 includes a lubricant brush 47a, a lubricant stick 47b, a lubricant pressing part 47c, and a fixing blade 47d.

The lubricant brush 47a is provided on the downstream side in the rotation direction of the photoreceptor 41 with respect to the cleaning unit 471. The lubricant pressing part 47c presses and holds the lubricant stick 47b against the lubricant brush 47a. The fixing blade 47d is provided on the downstream side in the rotation direction of the photoreceptor 41 with respect to the lubricant brush 47a.

The lubricant brush 47a is a roll-shaped brush member that is disposed at a position where a tip end portion of the lubricant brush 47a can contact the photoreceptor 41. Under the control of the controller 10, the lubricant brush 47a scrapes the lubricant from the lubricant stick 47b and performs, at the contact point with the photoreceptor 41, with—rotation such that the surface travels in the same direction as the travel direction of the surface of the photoreceptor 41, the lubricant is applied (supplied) to the photoreceptor 41.

A linear velocity ratio θ, which is a ratio of a surface velocity of the lubricant brush 47a to a surface velocity of the photoreceptor 41, is set to a value exceeding 1 as an initial value, and the linear velocity ratio θ is appropriately changed according to the endurance, the environment, or the like.

The lubricant stick 47b is obtained by, for example, melting and molding a lubricant in the form of powder of metal soap such as zinc stearate, followed by solidification. The lubricant stick 47b is arranged at a position with which a tip part of the lubricant brush 47a can be in contact, and is scraped off from the tip part by rotation of the lubricant brush 47a. The scraped lubricant is conveyed as it is to the photoreceptor 41 and supplied to the surface of the photoreceptor 41.

The lubricant pressing part 47c includes, for example, a compression spring that biases the lubricant stick 47b toward the lubricant brush 47a, and presses and holds the lubricant stick 47b against the lubricant brush 47a.

As the lubricant stick 47b becomes shorter due to consumption, the pressing force acting between the lubricant stick 47b and the lubricant brush 47a due to the elastic force of the compression spring of the lubricant pressing part 47c decreases according to Hooke's law. Accordingly, the frictional force between the lubricant brush 47a and the lubricant stick 47b decreases, and thus the amount of the lubricant that the lubricant brush 47a scrapes off from the lubricant stick 47b decreases.

The fixing blade 47d is formed, for example, by processing an elastic body such as polyurethane rubber into a flat plate shape. The fixing blade 47d is placed so as to be in contact with the photoreceptor 41 in a direction in which it is dragged on the surface of the photoreceptor 41 (trailing contact) and so that its tip slides on the photoreceptor 41.

The fixing blade 47d spreads the lubricant powder supplied to the surface of the photoreceptor 41 to form a film (lubricant layer) on the surface of the photoreceptor 41. The lubricant layer formed of zinc stearate is characterized by high releasability, that is, a high pure water contact angle and a small friction coefficient. Therefore, the lubricant layer formed with zinc stearate has satisfactory transferability and cleanability, and abrasion of the photoreceptor 41 is also suppressed. A longer lifetime is thereby achieved.

The cleaning unit 48 includes a blade member 48a that abuts on the intermediate transfer belt T. The cleaning unit 48 removes and collects the toner and the like remaining on the intermediate transfer belt T without being transferred onto the sheet P.

The sheet feed section 5 includes a plurality of sheet feed trays 51 to 53, and stores a plurality of different types of sheets P in the respective sheet feed trays 51 to 53. The sheet feed section 5 feeds the sheets P accommodated in a predetermined conveyance path to the image forming section 4.

The storage section 6 includes a hard disk drive (HDD) and a semiconductor memory. The storage section 6 stores data such as program data and various types of setting data in a manner readable and writable by the third controller 10.

The storage section 6 stores, as information on lubricant application, an initial rubbing force F1 that is a rubbing force of the lubricant brush 47a in an initial stage of the endurance, a terminal rubbing force F2 that is a rubbing force of the lubricant brush 47a in a terminal stage of the endurance, and the ease K of scraping of the lubricant stick 47b. The initial stage of the endurance is a state in which the remaining amount of the lubricant stick 47b is sufficient, and the terminal stage of the endurance is a state in which the remaining amount of the lubricant stick 47b is very small.

The operation display section 7 includes a liquid crystal display (LCD) having a touch screen, for example, and functions as a display unit 71 and an operation unit 72.

The display unit 71 displays various kinds of operation screens, operating situations of the respective functions, and so forth in accordance with display control signals received from the controller 10.

The operation unit 72 includes various operation keys such as a numeric keypad and a start key, and a touch screen formed in the display unit 71. The operation unit 72 accepts various kinds of input operation by a user and outputs an operation signal to the controller 10.

The communication section 8 includes a communication control card such as a local area network (LAN) card. The communication section 8 exchanges various kinds of data with an external device connected to a communication network such as a LAN or a wide area network (WAN).

The controller 10 includes a central processing unit (CPU), a random access memory (RAM), a read only memory (ROM), and the like. The CPU loads various programs stored in the ROM or the storage section 6 to the RAM, and cooperates with the loaded various programs to comprehensively control the operation of the components of the image forming apparatus 1.

### <Information on Lubricant Application >

Next, the initial rubbing force F1, the terminal rubbing force F2, and the ease of scraping K of the lubricant stick 47b, which are information relating to lubricant application, will be described.

The initial rubbing force F1 and the terminal rubbing force F2 are measured in advance before the image forming apparatus 1 is assembled. The rubbing force of the lubricant brush 47a is a measured value of torque required to rotate the lubricant brush 47a at a predetermined velocity when a predetermined object is pressed against the lubricant brush 47a.

Next, a method of measuring the rubbing force of the lubricant brush 47a will be described.

From the state where the lubricant brush 47a and the lubricant stick 47b are separated from each other, the lubricant stick 47b is gradually pressed against the lubricant brush 47a, and the rubbing force of the lubricant brush 47a is measured.

FIG. 4 shows the relationship between the pressing force of the lubricant brush 47a and the lubricant stick 47b and the rubbing force of the lubricant brush 47a. The horizontal axis in FIG. 4 represents the pressing force of the lubricant brush 47a and the lubricant stick 47b, and the vertical axis represents the rubbing force of the lubricant brush 47a. A solid line A1 shown in FIG. 4 represents a relationship between the pressing force of the lubricant brush 47a and the lubricant stick 47b in the initial stage of endurance and the rubbing force of the lubricant brush 47a in the initial stage of the endurance. A solid line A2 shown in FIG. 4 represents a relationship between the pressing force of the lubricant brush 47a and the lubricant stick 47b at the terminal stage of endurance and the rubbing force of the lubricant brush 47a at the terminal stage of the endurance.

In the region R1 shown in FIG. 4, the bristle tip of the lubricant brush 47a is in contact with the lubricant stick 47b in the initial stage of pressing the lubricant stick 47b against the lubricant brush 47a.

In the region R2, the lubricant brush 47a is further pressed against the lubricant stick 47b from the state of the region R1 and the bristles of the lubricant brush 47a falls down and the belly portion of the bristles on the inner side of the bristle tip is in contact with the lubricant stick 47b.

The relationship between the pressing force between the lubricant brush 47a and the lubricant stick 47b and the rubbing force of the lubricant brush 47a is different between the region R1 and the region R2. In the region R2, the pressing force between the lubricant brush 47a and the lubricant stick 47b is proportional to the rubbing force of the lubricant brush 47a.

When the lubricant brush 47a applies the lubricant to the photoreceptor 41 (during normal operation of the image forming apparatus 1), the bristles of the lubricant brush 47a fall and the belly portion of the bristles on the inner side of the bristle tip is in contact with the lubricant stick 47b. Therefore, in the region R2, the initial rubbing force F1 and the terminal rubbing force F2 are measured.

In a state where the lubricant stick 47b is pressed against the lubricant brush 47a with an initial pressing force G1 in the initial stage of the endurance, the initial rubbing force F1 that is a rubbing force of the lubricant brush 47a is measured.

As the lubricant stick 47b becomes shorter due to consumption, the pressing force between the lubricant brush 47a and the lubricant stick 47b decreases. Therefore, in a state where the lubricant stick 47b is pressed against the lubricant brush 47a at the terminal stage of the endurance with a terminal pressing force G2 that is a smaller pressing force than the initial pressing force G1, the terminal rubbing force F2 that is a rubbing force of the lubricant brush 47a is measured.

The change in the rubbing force of the lubricant brush 47a during endurance depends on the combination of the lubricant brush 47a and the lubricant. For example, when the lubricant brush 47a is combined with a lubricant that is easily scraped, damage to the lubricant brush 47a is small, and therefore, the amount of decrease in the rubbing force of the lubricant brush 47a during endurance is small. On the other hand, when the lubricant brush 47a is combined with a lubricant that is not easily scraped, damage to the lubricant brush 47a is great, and therefore, the amount of decrease in the rubbing force of the lubricant brush 47a during endurance is great.

The ease of scraping K of the lubricant stick 47b is measured in advance before assembly of the image forming apparatus 1. The ease of scraping K of the lubricant stick 47b is an inverse number of a measured value of hardness of the lubricant by a durometer (JIS K 6253-3).

At the time of assembly of the image forming apparatus 1, the controller 10 acquires information on lubricant application by receiving an input operation via the operation unit 72, and stores the information in the storage section 6. The controller 10 may acquire the information on lubricant application by reading the encoded information on lubricant application with the scanner section 3. In a case where a drum unit including the photoreceptor 41, the lubricant brush 47a, and the lubricant stick 47b includes a storage device that stores information on lubricant application, the controller 10 may acquire the information on lubricant application from the storage device when the drum unit is attached to the main body of the image forming apparatus 1.

### <Operation of Image Forming Apparatus >

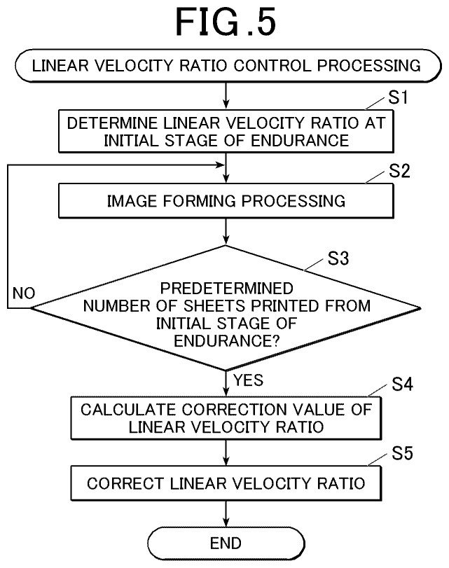

Next, operation of the image forming apparatus 1 will be described. The image forming apparatus 1 executes linear velocity ratio control processing shown in FIG. 5, which is a control step.

The image forming apparatus 1 executes Step S1 of the linear velocity ratio control processing in the initial stage of the endurance of the drum unit including the photoreceptor 41, the lubricant brush 47a, and the lubricant stick 47b. The image forming apparatus 1 executes Steps S2 to S5 of the linear velocity ratio control processing during normal operation.

### (Linear Velocity Ratio Control Processing)

The controller 10 of the image forming apparatus 1 calculates and determines the linear velocity ratio θ1 at the initial stage of the endurance by the following Formula (1) at the initial stage of the endurance of the drum unit (Step S1). In Step S1, the controller 10 acquires the initial rubbing force F1 and the ease K of scraping of the lubricant stick 47b from the storage section 6. A target value α in the lubricant consumption amount with respect to the number of printed sheets in the following Formula (1) is set in advance.

$$θ1 = α / ( F 1 \times K ) \qquad Formula ( 1 )$$

α: target value of lubricant consumption relative to number of printed sheets
F1: initial rubbing force of lubricant brush 47a
K: ease of scraping of lubricant stick 47b

Next, the controller 10 controls the photoreceptor 41 and the lubricant brush 47a of the image forming section 4 at the linear velocity ratio θ1 in the initial stage of the endurance calculated in Step S1, and executes image formation processing (Step S2).

Next, the controller 10 determines whether printing of a predetermined number of sheets has been performed by the image formation processing from the initial stage of the endurance (Step S3). The predetermined number of sheets is, for example, 1000 sheets.

In a case where the predetermined number of sheets has not been printed from the initial stage of the endurance (Step S3; NO), the controller 10 moves the linear velocity ratio control processing to Step S2.

On the other hand, when the predetermined number of sheets have been printed from the initial stage of the endurance (Step S3; YES), the controller 10 calculates a corrected value Δθ of the linear velocity ratio θ by the following Formula (2) (Step S4). In Step S4, the controller 10 acquires the initial rubbing force F1, the terminal rubbing force F2, and the ease K of scraping of the lubricant stick 47b from the storage section 6. An endurance correction coefficient γ in the following Formula (2) is a function of the ease K of scraping of the lubricant stick 47b and is a value corresponding to a combination of the lubricant and the lubricant brush 47a.

$$Δ θ = α / \{ ( F 1 - F 2 ) / ( P / P 0 ) \times γ \} \qquad Formula ( 2 )$$

α: target value of lubricant consumption relative to number of printed sheets
F1: initial rubbing force of lubricant brush 47a
F2: terminal rubbing force of lubricant brush 47a
P: number of printed sheets from initial stage of endurance
P0: number of printed sheets at terminal stage of endurance
γ: endurance correction coefficient

Next, the controller 10 corrects the current linear velocity ratio θ by the correction values A0 calculated in Step S4 (Step S5), and ends the linear velocity ratio control processing.

The controller 10 executes Steps S4 and S5 of the linear velocity ratio control processing for each predetermined number of printed sheets (e.g., 1000 sheets).

Next, examples of the present invention and comparative examples will be described. Hereinafter, the present embodiment will be specifically described with reference to Examples, but the present embodiment is not limited thereto.

### Comparative Examples

The linear velocity ratio θ1′ at the initial stage of the endurance in the comparative examples is calculated by the following Formula (3) as in the present embodiment.

$${θ1}^{′} = α / ( F 1 \times K ) \qquad Formula ( 3 )$$

α: target value of lubricant consumption relative to number of printed sheets
F1: initial rubbing force of lubricant brush 47a
K: ease of scraping of lubricant stick 47b

The linear velocity ratio θ2′ at the terminal stage of the endurance in Comparative Examples is calculated by the following Formula (4).

$${θ2}^{′} = {θ1}^{′} \times ( P / P 0 ) \times β \qquad Formula ( 4 )$$

P: number of printed sheets from initial stage of endurance
P0: number of printed sheets at terminal stage of endurance
β: change coefficient of pressing force due to endurance

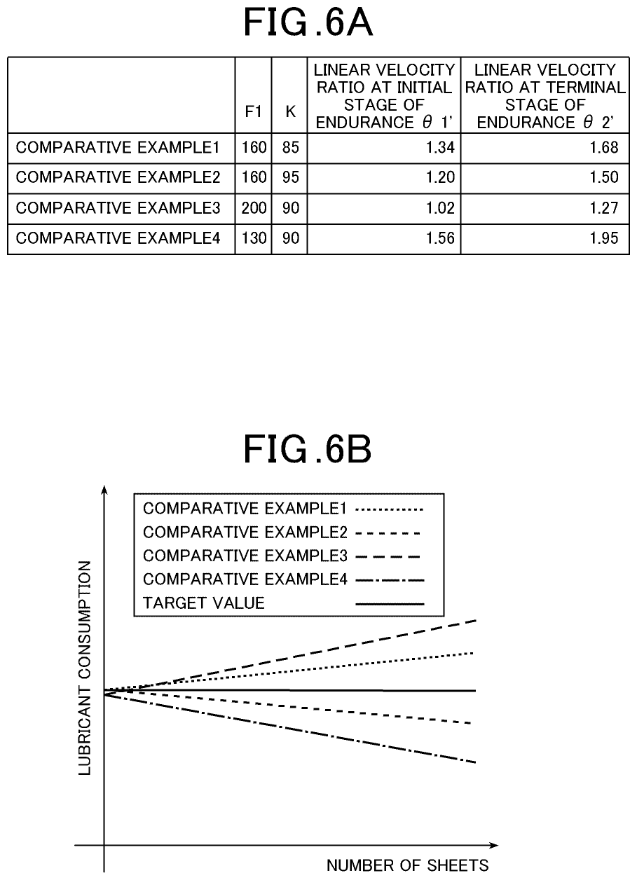

FIG. 6A shows the initial rubbing force F1, the ease K of scraping of the lubricant stick 47b, the linear velocity ratio θ1′ at the start of endurance, and the linear velocity ratio θ2′ at the terminal stage of the endurance in Comparative Examples 1 to 4.

FIG. 6B shows the target values of the amount of the lubricant consumed relative to the number of printed sheets and the changes in the amount of the lubricant consumed in Comparative Examples 1 to 4 during the endurance.

As shown in FIG. 6B, in Comparative Examples 1 and 3, as the number of printed sheets increases, the lubricant consumption amount increases more than the target value. On the other hand, in Comparative Examples 2 and 4, the lubricant consumption amount decreases below the target value as the number of printed sheets increases. That is, in Comparative Examples 1 to 4, the consumption amount of the lubricant is not constant during the endurance, an appropriate amount of the lubricant cannot be uniformly applied onto the photoreceptor 41, which may result in a vertical streak in the formed image.

### EXAMPLES

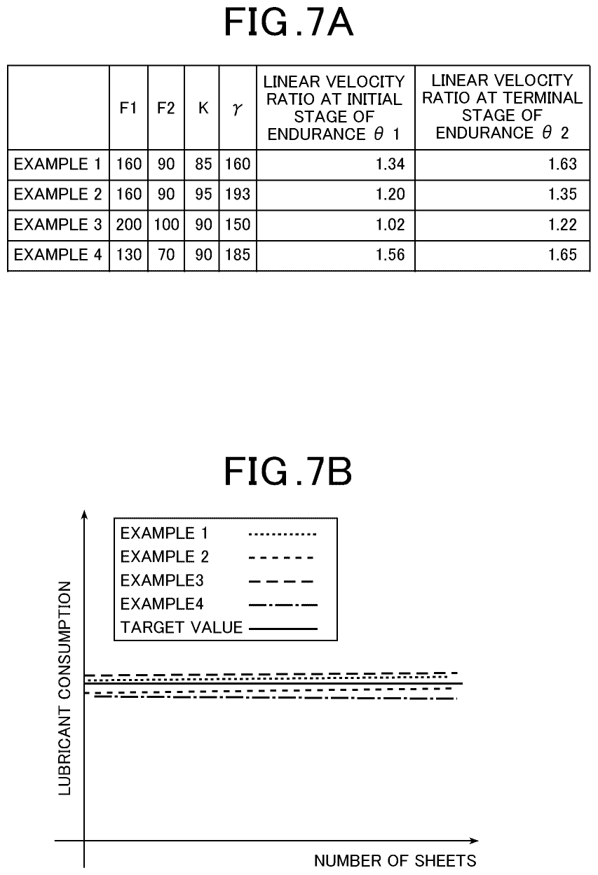

FIG. 7A shows the initial rubbing force F1, the terminal rubbing force F2, the ease K of scraping of the lubricant stick 47b, and the endurance correction coefficient γ in Examples 1 to 4 of the present invention.

FIG. 7A shows the linear velocity ratio θ1 at the initial stage of the endurance and the linear velocity ratio θ2 at the terminal stage of the endurance calculated by the controller 10 of the image forming apparatus 1 executing the above-described linear velocity ratio control processing.

FIG. 7B shows the target value of the lubricant consumption amount relative to the number of printed sheets and changes in the lubricant consumption amount during the endurance in Examples 1 to 4 according to the present invention.

As shown in FIG. 7B, in Examples 1 to 4 of the present invention, the lubricant consumption amount is substantially constant during the endurance. Therefore, in the present embodiment, an appropriate amount of the lubricant can be uniformly applied onto the photoreceptor 41, and vertical streaks in the formed image can be suppressed.

### <Effects>

As described above, the image forming apparatus 1 of the present embodiment includes the image forming section 4 including the image bearing member (photoreceptor 41) that bears the toner image and the lubricant application unit 472 that applies the lubricant to the image bearing member; and the controller 10 that controls the image forming section 4.

The lubricant application unit 472 includes the solidified lubricant stick 47b, the lubricant brush 47a that scrapes off the lubricant from the lubricant stick 47b and supplies the lubricant to the image bearing member, and the lubricant pressing part 47c that presses the lubricant stick 47b against the lubricant brush 47a.

The controller 10 controls the image bearing member and the lubricant brush 47a by the linear velocity ratio θ1 which is a surface velocity ratio of the lubricant brush with respect to a surface velocity of the image bearing member in the initial stage of the endurance calculated based on the initial rubbing force F1 which is a rubbing force of the lubricant brush 47a in a state where the lubricant stick 47b is pressed against the lubricant brush 47a with the initial pressing force in the initial stage of the endurance and the ease K of scraping of the lubricant.

The controller 10 corrects the linear velocity ratio θ by the correction value Δθ of the linear velocity ratio calculated by: the endurance correction coefficient γ according to the endurance change of the lubricant brush 47a determined by the ease K of scraping of the lubricant; the initial rubbing force F1; the terminal rubbing force F2 which is the rubbing force of the lubricant stick 47b in a state where the lubricant stick 47b is pressed against the lubricant brush 47a with a pressure weaker than the initial pressure at the terminal stage of the endurance; and the number of printed sheets by the image forming section 4.

The pressing force between the lubricant brush 47a and the lubricant stick 47b at the terminal stage of the endurance is proportional to the terminal rubbing force F2.

Therefore, the lubricant consumption amount relative to the number of printed sheets can be made substantially constant during the endurance. That is, an appropriate amount of the lubricant can be uniformly applied onto the photoreceptor 41, and vertical streaks in the formed image can be suppressed.

In the image forming apparatus 1 of the present embodiment, the controller 10 calculates the linear velocity ratio θ1 at the initial stage of the endurance by the following Formula (1). The controller 10 calculates the correction value Δθ of the linear velocity ratio by the following Formula (2).

$$θ1 = α / ( F 1 \times K ) \qquad ( 1 )$$

$$Δ θ = α / \{ ( F 1 - F 2 ) / ( P / P 0 ) \times γ \} \qquad ( 2 )$$

α is a target value in the lubricant consumption amount with respect to the number of printed sheets, F1 is the initial rubbing force, F2 is the terminal rubbing force, K is the ease of scraping of the lubricant, P is the number of printed sheets, P0 is the number of printed sheets in the terminal stage of the endurance, and γ is an endurance correction coefficient with respect to the linear velocity ratio.

Therefore, it is possible to easily make the lubricant consumption amount with respect to the number of printed sheets during the endurance substantially constant based on the above formula.

In the image forming apparatus 1 of the present embodiment, the controller 10 calculates the correction value Δθ of the linear velocity ratio for each predetermined number of printed sheets, and corrects the linear velocity ratio by the correction value Δθ.

Therefore, by correcting the linear velocity ratio for every predetermined number of printed sheets, the lubricant consumption amount relative to the number of printed sheets can be made substantially constant during the endurance.

The technical scope of the present embodiment is not limited to the above-described embodiment, and includes various modifications to the above-described embodiment without departing from the spirit of the present invention.

For example, in the above-described embodiment, the image forming section 4 includes the image forming units for the respective colors of Y, M, C, and K, but is not limited thereto. For example, the present embodiment can be applied to a monochrome image forming apparatus including only one imaging section.

The present embodiment can also be applied to an image forming apparatus of a direct transfer type in which the intermediate transfer belt T, the primary transfer roller 45, and the like are omitted and an image is directly transferred from the photoreceptor 41 to the sheet P.

In addition, each of conventionally used electrophotographic process technologies can be combined with any configuration according to the purpose of the image forming apparatus.

In addition, the specific configurations, the contents and procedures of the processing operations, and the like described in the above embodiment can be appropriately changed without departing from the spirit and scope of the present invention. It is intended that the scope of the present invention includes the scope of the invention described in the scope of the claims and the scope of equivalents thereof.

Although embodiments of the present invention have been described and shown in detail, the disclosed embodiments are made for purposes of illustration and example only and not limitation. The scope of the present invention should be interpreted by terms of the appended claims.

What is claimed is:

1. An image forming apparatus comprising:
an image forming section including an image bearing member that bears a toner image and a lubricant application unit that applies lubricant to the image bearing member; and
a hardware processor that controls the image forming section,
wherein the lubricant application unit includes: a solidified lubricant stick; a lubricant brush that scrapes off the lubricant from the lubricant stick and supplies the lubricant to the image bearing member; and a lubricant pressing part that presses the lubricant stick against the lubricant brush,
wherein the hardware processor:
controls the image bearing member and the lubricant brush according to a linear velocity ratio which is a ratio of a surface velocity of the lubricant brush with respect to a surface velocity of the image bearing member in an initial stage of endurance, the linear velocity ratio being calculated based on an initial rubbing force and an ease of scraping of the lubricant, the initial rubbing force being a rubbing force of the lubricant brush in a state where the lubricant stick is pressed against the lubricant brush with an initial pressing force in the initial stage of the endurance; and
corrects the linear velocity ratio by a correction value of the linear velocity ratio calculated based on an endurance correction coefficient according to an endurance change of the lubricant brush determined by the ease of scraping of the lubricant, the initial rubbing force, a terminal rubbing force which is a rubbing force of the lubricant brush in a state where the lubricant stick is pressed to the lubricant brush by a pressing force weaker than the initial pressing force in a terminal stage of the endurance, and the number of printed sheets by the image forming section,
wherein the pressing force between the lubricant brush and the lubricant stick in the terminal stage of the endurance is in a proportional relationship with the terminal rubbing force.

2. The image forming apparatus according to claim 1,
wherein the hardware processor calculates a linear velocity ratio θ1 at the initial stage of the endurance by the following formula (1), and calculates a correction value Δθ of the linear velocity ratio by the following formula (2):
$$θ1 = α / ( F 1 \times K ) \qquad ( 1 )$$
$$Δ θ = α / \{ ( F 1 - F 2 ) / ( P / P 0 ) \times γ \} \qquad ( 2 )$$
wherein α is a target value in a lubricant consumption amount with respect to the number of printed sheets, F1 is the initial rubbing force, F2 is the terminal rubbing force, K is the ease of scraping of the lubricant, P is the number of printed sheets, P0 is the number of printed sheets in the terminal stage of the endurance, and γ is the endurance correction coefficient with respect to the linear velocity ratio.

3. The image forming apparatus according to claim 1,
wherein the hardware processor calculates the correction value for each predetermined number of printed sheets and corrects the linear velocity ratio with the correction value.

4. A control method executed by an image forming apparatus, the image forming apparatus comprising:
an image forming section including an image bearing member that bears a toner image and a lubricant application unit that applies a lubricant to the image bearing member,
wherein the lubricant application unit includes: a solidified lubricant stick; a lubricant brush that scrapes off lubricant from the lubricant stick and supplies the lubricant to the image bearing member; and a lubricant pressing portion that presses the lubricant stick against the lubricant brush,
wherein the control method comprises controlling the image forming section,
wherein in the controlling,
the image bearing member and the lubricant brush are controlled according to a linear velocity ratio which is a ratio of a surface velocity of the lubricant brush with respect to a surface velocity of the image bearing member in an initial stage of endurance, the linear velocity ratio being calculated based on an initial rubbing force and an ease of scraping of the lubricant, the initial rubbing force being a rubbing force of the lubricant brush in a state where the lubricant stick is pressed against the lubricant brush with an initial pressing force in the initial stage of the endurance; and
the linear velocity ratio is corrected by a correction value of the linear velocity ratio calculated based on an endurance correction coefficient according to an endurance change of the lubricant brush determined by the ease of scraping of the lubricant, the initial rubbing force, a terminal rubbing force which is a rubbing force of the lubricant brush in a state where the lubricant stick is pressed to the lubricant brush by a pressing force weaker than the initial pressing force in a terminal stage of the endurance, and the number of printed sheets by the image forming section,
wherein the pressing force between the lubricant brush and the lubricant stick in the terminal stage of the endurance is in a proportional relationship with the terminal rubbing force.

5. A non-transitory computer-readable storage medium storing a program that causes a computer of an image forming apparatus to function as a controller,
wherein the image forming apparatus comprises an image forming section including an image bearing member that bears a toner image and a lubricant application unit that applies a lubricant on the image bearing member,
wherein the lubricant application unit includes: a solidified lubricant stick; a lubricant brush that scrapes off lubricant from the lubricant stick and supplies the lubricant to the image bearing member; and a lubricant pressing portion that presses the lubricant stick against the lubricant brush,
wherein the controller:
controls the image bearing member and the lubricant brush according to a linear velocity ratio which is a ratio of a surface velocity of the lubricant brush with respect to a surface velocity of the image bearing member in an initial stage of endurance, the linear velocity ratio being calculated based on an initial rubbing force and an ease of scraping of the lubricant, the initial rubbing force being a rubbing force of the lubricant brush in a state where the lubricant stick is pressed against the lubricant brush with an initial pressing force in the initial stage of the endurance; and
corrects the linear velocity ratio by a correction value of the linear velocity ratio calculated based on an endurance correction coefficient according to an endurance change of the lubricant brush determined by the ease of scraping of the lubricant, the initial rubbing force, a terminal rubbing force which is a rubbing force of the lubricant brush in a state where the lubricant stick is pressed to the lubricant brush by a pressing force weaker than the initial pressing force in a terminal stage of the endurance, and the number of printed sheets by the image forming section,
wherein the pressing force between the lubricant brush and the lubricant stick in the terminal stage of the endurance is in a proportional relationship with the terminal rubbing force.
